(19) United States
(12) Patent Application Publication
(10) Pub. No.: US 2006/0259425 A1
(43) Pub. Date: Nov. 16, 2006

(54) SECURITY SYSTEMS FOR A PAYMENT INSTRUMENT

(75) Inventors: Kenneth E. Jennings JR., Davie, FL (US); Keith Newbrough, Parker, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/382,866

(22) Filed: May 11, 2006

Related U.S. Application Data
(60) Provisional application No. 60/757,946, filed on Jan. 10, 2006.
(60) Provisional application No. 60/680,379, filed on May 11, 2005.

(51) Int. Cl. G06K 5/00; G06Q 40/00; G06Q 99/00; H04L 9/00; H04K 1/00

(52) U.S. Cl. 705/40; 235/380; 705/64

(57) ABSTRACT

The invention provides improved security for stored-value instruments. For example, an instrument-authority system may receive a first identifier for an instrument and may thereupon authenticate the instrument, but the system may wait before activating the instrument, such that the instrument may be unusable for a period of time to allow for cancellation of activation if payment is not received for the stored-value instrument.

### CROSS-REFERENCES TO RELATED APPLICATIONS

This application claims the benefit of the filing date of provisional U.S. Patent Application No. 60/680,379, filed May 11, 2005 by Kenneth E. Jennings, Jr. and entitled “Security Systems for a Payment Instrument,” the complete disclosure of which is incorporated herein by reference.

This application also claims the benefit of the filing date of provisional U.S. Application No. 60/757,946, filed Jan. 10, 2006 by Kenneth E. Jennings, Jr. and entitled “Security Systems for a Payment Instrument.” the complete disclosure of which is incorporated herein by reference.

### BACKGROUND OF THE INVENTION

This application relates generally to stored-value instruments. More specifically, this application relates to methods and systems for processing stored-value instruments.

In recent years, stored-value cards have become increasingly popular among consumers. The steadily increasing demand for such cards, in the form of prepaid gift cards and other types of stored-value cards, has resulted in an increased number of merchants offering stored-value cards for sale. This success in marketing stored-value cards has, however, spawned a variety of fraudulent practices related to these cards.

There is, accordingly, a general need in the art for methods and systems to provide more security for stored-value instruments.

### BRIEF SUMMARY OF THE INVENTION

The invention provides improved security for stored-value instruments. For example, an instrument-authority system may receive a first identifier for an instrument and may thereupon authenticate the instrument, but the system may wait for confirmation that payment for the instrument has been received before activating the instrument, such that the instrument may be unusable until payment has been confirmed and the instrument has been activated. Additionally and/or alternatively, the system may wait for a period of time before activating the instrument, allowing a certain period of time for the system to be notified not to activate the instrument. The system may place the instrument in an inactive state in response to such request. An instrument in an inactive state may be re-authenticated and/or activated at some time in the future. The instrument-authority system may periodically review instruments in an inactive state and may activate, cancel, and/or do nothing to such instruments.

Various embodiments of the invention, then, may provide methods, systems and/or software for processing stored value instruments. A set of embodiments, for example provides methods for processing stored-value instruments. An exemplary method may comprise receiving at a point-of-sale device (which might be a cash register, point-of-sale terminal, etc.) an identifier identifying a stored-value instrument. In a particular embodiment, for example, the instrument may comprise a magnetic stripe and/or receiving the identifier comprise a clerk (and/or another) swiping the magnetic stripe through a magnetic stripe reader. The method may further comprise transmitting from the point-of-sale device a request for authentication of the stored-value instrument. The method might further comprise authenticating the stored-value instrument, perhaps in response to the request for authentication.

In some embodiments, the method further comprises confirming (e.g., at the point-of-sale device) that payment for the stored-value instrument has been received. This confirmation may include, merely by way of example, receiving input from a clerk indicating that payment has been tendered, processing a credit card or debit card transaction related to a purchase of the stored-value instrument, and/or the like. Additionally and/or alternatively, confirmation may automatically occur after a certain period of time unless payment is not received.

The method may further comprise transmitting from the point-of-sale device a confirmation that payment for the stored value instrument has been received. The stored-value instrument may then be activated, perhaps in response to the confirmation. In a particular set of embodiments, authenticating the stored-value instrument may comprise placing an account associated with the stored-value instrument in a frozen state, such that no funds associated with the account may be accessed by a user of the stored-value instrument, and/or activating the stored-value instrument may comprise placing the account in an unfrozen state, such that funds associated with the stored-value instrument can be accessed by the user of the stored-value instrument.

Another exemplary method of processing a stored-value instrument may comprise receiving at an instrument-authority system an authentication request from a point-of-sale device; the request for authentication may comprise a request to authenticate a stored-value instrument. The method, then, may further comprise authenticating at the instrument-authority system the stored-value instrument, perhaps in response to the authentication request received from the point-of-sale device. The stored-value instrument may be placed in a frozen state, such that funds in an account associated with the stored-value instrument cannot be accessed by a user of the stored-value instrument.

In some embodiments, the method may further comprise receiving at the instrument-authority system a confirmation from the point-of-sale device that payment for the stored value has been received and/or activating the stored-value instrument. Hence, finds in the account associated with the stored-value instrument may possibly be accessed by a user of the stored-value instrument. Additionally and/or alternatively, the method may comprise receiving at the instrument-authority system a notification from the point-of-sale device that payment for the stored value has not been received within a certain period of time. Hence, in these embodiments, after such notification is received, funds in the account associated with the stored-value instrument may be permanently and/or temporarily deactivated, such that they may not be accessed by a user of the stored-value instrument. The method may place the instrument in an inactive state in response to such notification.

Another set of embodiments provides systems for processing stored-value instruments, including without limitation systems configured to perform methods of the invention. An exemplary system comprises a point-of-sale device and an instrument-authority system. The point of sale device may be configured to receive an identifier identifying a stored-value instrument and/or to transmit a request for authentication of the stored value instrument. In some embodiments, the point-of-sale device may be further configured to confirm that payment for the stored-value instrument has been received and/or to transmit a confirmation that payment for the stored value instrument has been received.

The instrument-authority system, which may be in communication with the point-of-sale device, may comprise a communications system, a processor in communication with the communications system, and/or a memory coupled with the processor. The memory may comprise a computer-readable storage medium having a computer-readable program embodied therein for directing operation of the instrument-authority system. The computer-readable program may comprise instructions for receiving the request for authentication and/or instructions for authenticating the stored-value instrument in response to the request for authentication. The program may further comprise instructions for receiving the confirmation that payment for the stored value instrument has been received and/or instructions for activating the stored-value instrument, perhaps in response to the confirmation that payment has been received and/or perhaps after a certain period of time has passed.

Another exemplary system may comprise a communications system, a storage device, a processor in communication with the communications system and the storage device, and/or a memory coupled with the processor. The memory may comprise a computer-readable storage medium having a computer-readable program embodied therein for directing operation of the system. The computer-readable program may comprise instructions for receiving an authentication request from a point-of-sale device; the request for authentication may comprise a request to authenticate a stored-value instrument.

The program may further comprise instructions for authenticating the stored-value instrument, perhaps in response to the authentication request received from the point-of-sale device and/or instructions for placing the stored-value instrument into a frozen state, such that funds in an account associated with the stored-value instrument cannot be accessed by a user of the stored-value instrument. In particular embodiments, the program may further comprise instructions for receiving a confirmation from the point-of-sale device that payment for the stored value has been received and/or instructions for activating the stored-value instrument, such that, e.g., funds in the account associated with the stored-value instrument can be accessed by a user of the stored-value instrument. Additionally and/or alternatively, the program may comprise instructions for activating the stored-value instrument after a certain period of time has passed unless notification is received that no payment was tendered for the instrument. The program may place the instrument in an inactive state in response to such a notification.

Yet another set of embodiments provides software programs, including without limitation programs comprising instructions for implementing methods of the invention. An exemplary program, which may be embodied on at least one computer readable medium, may comprise instructions for receiving an authentication request from a point-of-sale device; the request for authentication may comprise a request to authenticate a stored-value instrument.

The program may further comprise instructions for authenticating the stored-value instrument, perhaps in response to the authentication request received from the point-of-sale device and/or instructions for placing the stored-value instrument into a frozen state, such that funds in an account associated with the stored-value instrument cannot be accessed by a user of the stored-value instrument. In particular embodiments, the program may further comprise instructions for receiving a confirmation from the point-of-sale device that payment for the stored value has been received and/or instructions for activating the stored-value instrument, such that, e.g., funds in the account associated with the stored-value instrument can be accessed by a user of the stored-value instrument. Additionally and/or alternatively, the program may comprise instructions for activating the stored-value instrument after a certain period of time has passed unless notification is received that no payment was tendered for the instrument. The program may place the instrument in an inactive state in response to such a notification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1A provides a block diagram representation of a system arrangement used for implementing embodiments of the invention;

FIG. 1B provides a schematic illustration of a flow of information through the system of FIG. 1A according to embodiments of the invention;

FIG. 2 is a flow diagram that summarizes methods of the invention in certain embodiments;

FIG. 3 is a schematic diagram of a point-of-sale terminal that may be used with the system of FIG. 1A; and

FIG. 4 is a schematic illustration of a computer system on which methods of the invention may be embodied.

### DETAILED DESCRIPTION OF THE INVENTION

Embodiments of the invention permit retailers to continue to use traditional methods of displaying and selling stored-value presentation instruments, while providing enhanced security to prevent unauthorized and/or fraudulent use of unpurchased cards. A stored-value presentation instrument can be any instrument (tangible or intangible) that may be associated with a debit account and/or may otherwise be presented for payment for goods and/or services, used to transfer money, etc. Particular embodiments of stored-value instruments comprise stored-value cards, which may have a form factor similar to that of credit cards, etc. In a set of embodiments, stored-value instruments, such as cards may be packaged in a manner described in detail in U.S. patent application Ser. No. 10/665,984, filed Sep. 19, 2003 by McGee et al. and entitled “Financial Presentation Instruments with Integrated Holder and Methods for Use,” the entire disclosure of which is incorporated herein by reference.

In many cases, a stored-value instrument may comprise some form of identifier, which may be sufficient to uniquely identify the stored-value instrument. Merely by way of example, an instrument may comprise a magnetic stripe, memory chip, RFID tag, bar code and/or any other device known in the art for storing card information. The identifier, which might be a serial number and/or other string of text and/or numbers, then, might be encoded onto and/or stored in the magnetic stripe, chip, RFID tag, etc. and/or represented by the bar code. Those skilled in the art will appreciate the variety of methods that can be used to encode/decode a magnetic stripe and/or translate a bar code.

A set of embodiments provides systems for processing stored-value instruments. An system in accordance with some embodiments may have components similar to those described in U.S. patent application Ser. No. 10/405,043, filed Sep. 26, 2003 by McGee et al. and entitled “Methods and Systems for Processing Unrestricted Stored-Value Instruments,” the entire disclosure of which is incorporated herein by reference. Other structural systems may be used as well.

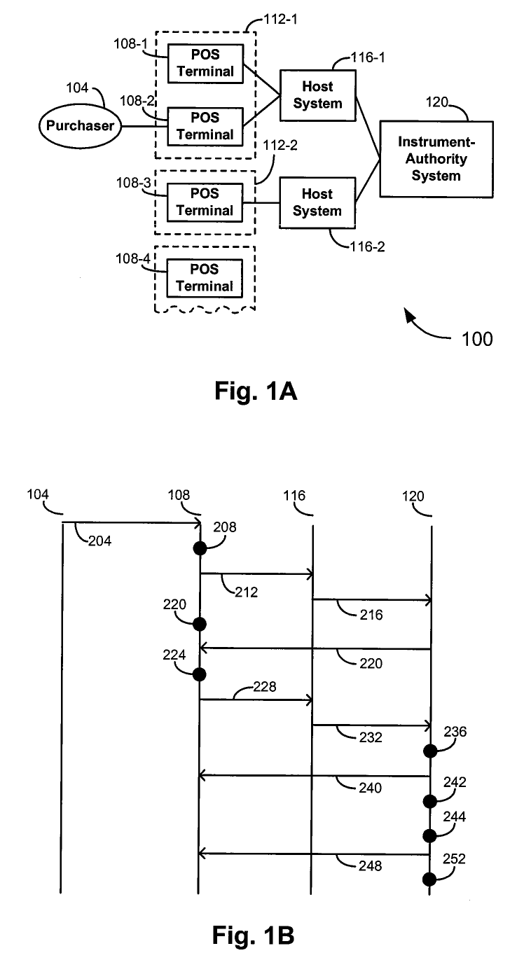

Merely by way of example, an overview of a structural system that may be used to implement methods of the invention is illustrated schematically in FIG. 1A. The stored-value instruments may be purchased by a purchaser 104 at a merchant location 112. Each merchant location 112 may include one or more point-of-sale terminals 108 having a capacity for reading information from the stored-value instrument. Each point-of-sale terminal 108 may be configured for interacting with an instrument-authority system 120, perhaps through a host system 116 configured to interface directly with each of the point-of-sale terminals 108 at a particular merchant location 112. The instrument-authority system 120 may be adapted to manage the authentication and use of the stored-value instruments as described in further detail below. (In some embodiments, the host system 116 may be configured to perform the functions attributed herein to the instrument-authority system. In other embodiments, the host system 116 may be omitted and/or the instrument-authority system 120 may be configured to communicate directly with the point-of-sale terminals 108).

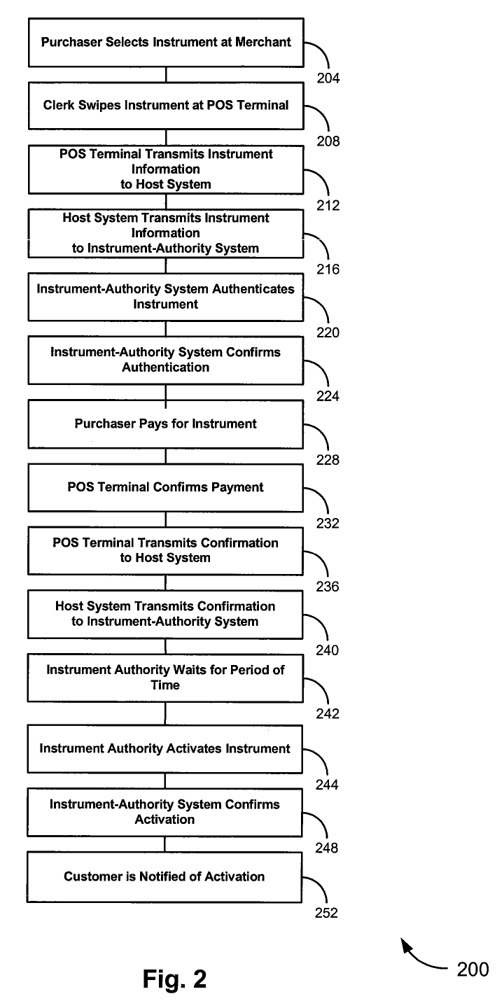

The manner in which the structural system illustrated in FIG. 1A may be used to implement embodiments of the invention is illustrated simultaneously with the schematic diagram of FIG. 1B and the flow diagram of FIG. 2, which illustrates a method 200 in accordance with embodiments of the invention. While FIG. 2 uses blocks to indicate functions that may be performed in implementing methods of the invention in some embodiments, FIG. 1B uses arrows to illustrate a corresponding flow of information through the system in FIG. 1A as those functions are performed. Thus, at block 204, a purchaser 104 selects an instrument for purchase at a merchant location 112. Typically, the instrument is chosen from a plurality of instruments at a merchant display, with different instruments being associated with different value amounts. In some instances, the instruments may not be associated with any particular value amount, and/or a value may be assigned to a particular instrument at the time of authentication and/or activation of the instrument, as described in more detail below.

After one of the instruments is selected for purchase, it may be presented to a clerk at the merchant location 112 with payment, such as in the form of a credit card, debit card, cash, check, or the like. At block 208, the clerk (and/or the purchaser 104 or another) provides an instrument identifier for the instrument to a point-of-sale terminal 108, such as by swiping a card through a magnetic stripe reader so that an encoded identifier may be extracted from a magnetic strip affixed to the card. In alternative embodiments, other techniques may be used to obtain the identifier, including through optical scanning, bar-code scanning, and the like. In some embodiments, as described above, the identifier may be embossed and/or printed on the card, and providing the instrument identifier may comprise the clerk (and/or another) typing the identifier into a keypad associated with the point-of sale terminal. Hence, the point-of-sale terminal 108 receives the identifier. After receiving the identifier, the instrument information is transmitted by the point-of-sale terminal 108 to a host system 116 at block 212, and transmitted from the host system 116 to the instrument-authority system 120 at block 216. The instrument information may include the identifier and/or any other appropriate information. In a particular set of embodiments (for example, when the instrument is not associated with any particular pre-determined value), the instrument information may include a value of the instrument, perhaps based on the purchase price of the instrument.

The instrument-authority system 120 acts at block 220 to authenticate the instrument by validating the received identifier as corresponding to a previously unauthenticated instrument. The authentication may also comprise creating an account associated with the instrument, and/or crediting that account with an amount of finds associated with the instrument. This amount may be pre-determined and/or based on a value paid for the instrument (which may, as noted above, be communicated by the point of sale terminal 108 to the instrument-authority system). It is noted that the authentication performed at block 220 may not result in full activation of an unrestricted instrument. In particular, the account may be placed in a locked and/or “frozen” state during the authentication process. In other words, the account may be designated inactive, such that it may not be used (i.e., funds associated with the account may not be accessed by a user of the instrument). In this way, the system can insulate the instrument from fraud.

Optionally, the instrument-authority system 120 may provide a confirmation to the point-of-sale terminal 108 (e.g., via the host 116) that the instrument has been authenticated (block 224). This confirmation might (but need not necessarily) include a transaction and/or confirmation number. At block 228, the purchaser 104 pays for the instrument. Payment may be tendered in any acceptable format, and/or in any of several known methods. Merely by way of example, the purchaser 104 may tender cash for the instrument. Alternatively and/or in addition, a credit and/or debit card payment may be processed, perhaps using the point-of-sale terminal 108. Other forms of payment, including checks, direct debit, etc. may be used as well. Those skilled in the art will appreciate that in many cases, items additional to a stored-value instrument may be purchased along with the instrument, and/or payment for some or all of the additional items may be tendered along with payment for the instrument, perhaps as part of a single transaction (cash payment, credit card authorization, etc.)

The point-of-sale terminal 108 then, confirms that payment has been received (block 232). In some cases, the point-of-sale terminal 108 may be used to process the payment (such as, for instance, when the point-of sale terminal 108 is used to process a credit/debit card payment, and/or when the point of sale terminal 108 also serves as a cash register, such that the clerk enters the amount of payment into the terminal 108 to finalize the sale transaction), and/or confirmation thus may be implicit in the terminal's processing of the payment. In other cases, the clerk (and/or another) may indicate (for instance, through keypad input) that payment has been received. In a particular set of embodiments, for example, the terminal 108 may prompt the clerk to provide confirmation that payment has been received, and/or the clerk may press a designated key (or set of keys), with or without prompting from the terminal 108, to indicate the instrument has been paid for.

In accordance with some embodiments, the point-of-sale terminal 108 may transmit a confirmation to the host system 116 that payment for the instrument has been received (block 236). In some embodiments, confirmatory details about the payment transaction (e.g., form of payment, credit card authorization number, etc.) may be provided as part of the transmitted confirmation. In other embodiments, however, the terminal 108 may simply send a confirmation (without additional details) that payment has been received. The host 116 may then transmit the confirmation to the instrument-authority system 120 (block 240). (In some cases, as noted above, the host 116 may perform the functions of the instrument-authority system 120, so this step may be unnecessary). In other embodiments, in addition to, or instead of, the point-of-sale terminal 108 transmitting a confirmation, the instrument-authority system 120 may be configured to wait for a certain period of time to pass (block 242), before activating the instrument (block 244). Merely by way of example, the instrument-authority system 120 may wait 15 minutes, 30 minutes, 1 hour, 12 hours, 1 day or any other appropriate time before activating the instrument (block 244). In another example, the instrument authority system may request a period of time parameter from a database, and after receiving such parameter, wait for the period of time specified by the parameter before activating the instrument (block 244). In another example, the point-of-sale terminal, or other device, may notify the instrument-authority system that the instrument should not be activated, for instance, if payment has not been received for the instrument. In such an example, the instrument-authority system may transmit a notice to the point-of-sale device that the instrument will not be activated (e.g. a transaction declination, a denial message, etc.). The instrument-authority system may also place the instrument in an inactive state in response to the notification that the instrument should not be activated. An instrument in an inactive state may be re-authenticated and/or activated at some time in the future. The instrument-authority system may periodically review instruments in an inactive state and may activate, cancel, and/or do nothing to such instruments.

At block 244, the instrument-authority system 120 activates the instrument (and/or an account associated with the instrument). In a set of embodiments, this activation enables the use of the instrument. As noted above, the instrument (and/or an account associated therewith) may be placed in a “frozen” status upon authentication (i.e., at block 220), such that funds associated with the instrument cannot be used until the instrument and/or account is unfrozen. At this point, payment for the instrument has been confirmed, so the instrument and/or account can be unfrozen and/or placed in an active state, such that the instrument can be used for purchases, cash withdrawals, money transfers, etc. Optionally, activating the instrument may comprise verifying any details of a payment confirmation (such as verifying that the point-of-sale terminal 108 actually processed a credit card authorization, if the transmitted confirmation indicates that a credit card was used to pay for the instrument).

In some embodiments, the instrument-authority system 120 may provide a confirmation to the point-of-sale terminal 108 (e.g., via the host 116) that the instrument (and/or an account associated therewith) has been activated (block 248). Accordingly, if desired, the terminal 108 may display a confirmation of the activation, and/or the terminal 108 and/or the clerk may notify the customer that the instrument has been activated (block 252).

Since transmission of information related to the stored-value instrument may form only a part of the transaction, the point-of-sale terminal 108 may additionally be employed to capture information needed also to complete the remainder of the transaction. Accordingly, the point-of-sale terminal 108 may include or be in communication with associated equipment or devices used for capturing such information, such as bar-code information identifying an item that forms part of the full transaction. Furthermore, the point-of-sale terminal 108 may include other components that facilitate execution of a transaction, such as payment-information-entry components, signature-capture components, keypads, keyboards, display screens, biometric-data-capture components, speakers, printers, processors, software, memory, communication devices, and the like. Examples of suitable point-of-sale devices that include multiple capabilities are provided in the following commonly assigned applications, the entire disclosures of which are incorporated herein by reference for all purposes: U.S. Prov. Pat. Appl. No. 60/147,889, entitled “INTEGRATED POINT OF SALE DEVICE,” filed Aug. 9, 1999 by Randy J. Templeton et al.; U.S. patent application Ser. No. 09/634,901, entitled “POINT OF SALE PAYMENT SYSTEM,” filed Aug. 9, 2000 by Randy J. Templeton et al.; U.S. patent application Ser. No. 10/116,689, entitled “SYSTEMS AND METHODS FOR PERFORMING TRANSACTIONS AT A POINT-OF-SALE,” filed Apr. 3, 2002 by Earney Stoutenburg et al; U.S. patent application Ser. No. 10/116,733, entitled “SYSTEMS AND METHODS FOR DEPLOYING A POINT-OF-SALE SYSTEM,” filed Apr. 3, 2002 by Earney Stoutenburg et al.; U.S. patent application Ser. No. 10/116,686, entitled “SYSTEMS AND METHODS FOR UTILIZING A POINT-OF-SALE SYSTEM,” filed Apr. 3, 2002 by Earney Stoutenburg et al.; and U.S. patent application Ser. No. 10/116,735, entitled “SYSTEMS AND METHODS FOR CONFIGURING A POINT-OF-SALE SYSTEM,” filed Apr. 3, 2002 by Earney Stoutenburg.

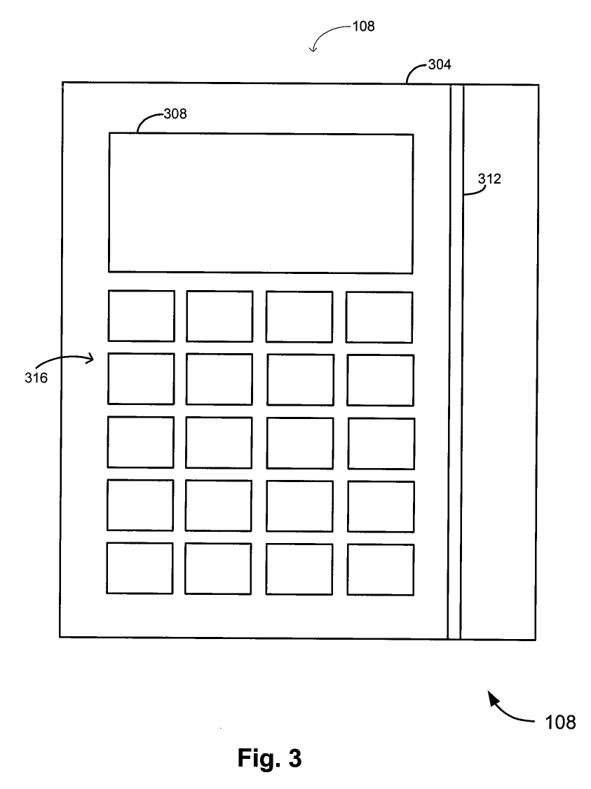

One specific example of how a point-of-sale terminal 108 may be constructed is illustrated in FIG. 3. In this embodiment, the point-of-sale terminal 108 comprises a housing 304 having a keypad 316 for entering various types of information. The keys of the keypad 316 may permit the entry of numbers or letters, or may be function keys for performing various predefined functions. The terminal 108 further includes a display screen 308 for displaying information relating to a transaction. A card reader 312 is also provided for reading information from cards, such as from a magnetic stripe included on instruments that have the form of cards. The card reader 312 may thus read payment information, identification information, and the like from encoding on the cards. In some instances, the point-of-sale terminal 108 may be connected to an attached printer, such as an FDX-400 printer available from AXIOHM.

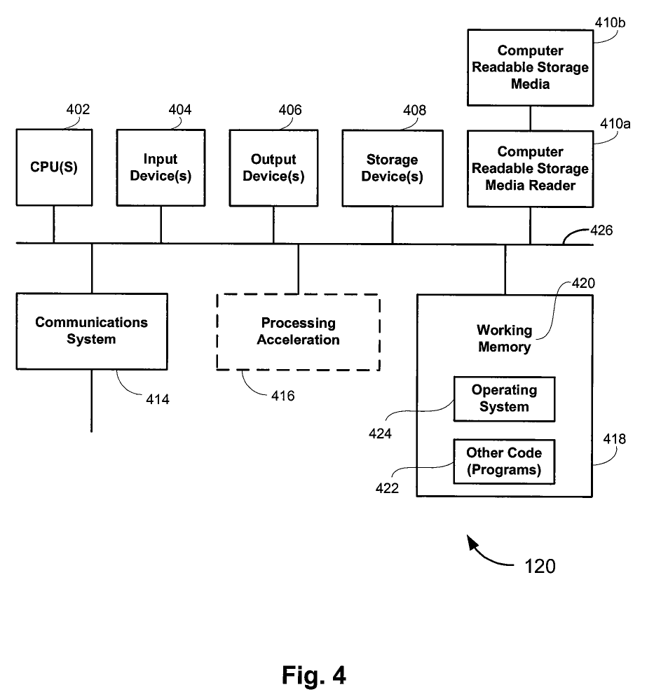

FIG. 4 provides a schematic illustration of a structure that may be used to implement the instrument-authority system 120; a similar structure may be used for implementation of the host system 116. FIG. 4 broadly illustrates how individual system elements may be implemented in a separated or more integrated manner. The instrument-authority system 120 is shown comprised of hardware elements that are electrically coupled via bus 426, including a processor 402, an input device 404, an output device 406, a storage device 408, a computer-readable storage media reader 410a, a communications system 414, a processing acceleration unit 416 such as a DSP or special-purpose processor, and a memory 418. The computer-readable storage media reader 410a is further connected to a computer-readable storage medium 410b, the combination comprehensively representing remote, local, fixed, and/or removable storage devices plus storage media for temporarily and/or more permanently containing computer-readable information. The communications system 414 may comprise a wired, wireless, modem, and/or other type of interfacing connection and permits data to be exchanged with the host system 116, point-of-sale terminals 108, as described in connection with FIGS. 1A, 1B, and 2.

The instrument-authority system 120 also comprises software elements, shown as being currently located within working memory 420, including an operating system 424 and other code 422, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

It should be noted that the methods, systems and devices discussed above are intended merely to be exemplary in nature. Consequently, various embodiments may omit, substitute and/or add various procedures and/or components as appropriate. For example, it should be appreciated that in alternative embodiments, the methods may be performed in an order different than that described.

In addition, while an exemplary process for activating a presentation instrument has been described above, embodiments of the invention could be used in any process in which there is a risk of fraud. Merely by way of example, those skilled in the art will appreciate that a customer, rather than purchasing a new card, often will desire to reload or recharge (i.e., add funds to) an existing instrument (or, in some cases, an account associated therewith). Accordingly, in a set of embodiments, instead of selecting an instrument (e.g., at block 204), a customer might instead provide a previously-purchased card to a clerk for recharge.

In such embodiments, the method 200 might proceed as described above, but perhaps with some variations. For instance, in some cases, the instrument may not need to be authenticated, so block 220 might be omitted. (In other cases, however, the instrument, even though previously purchased, might still be authenticated, for example, as described above.) Further, instead of paying for the instrument, at block 228, the customer generally would provide a payment equal to the “reload” amount (perhaps less some service fee, which could be an absolute fee, a percentage of the reload amount, etc.). Additionally, in some cases, instead of placing the instrument or account in a frozen or locked status (as described above), the system may simply place the reloaded funds into a frozen and/or locked state, such that at block 244, the system merely activates the amount of funds reloaded onto the instrument (and/or into an account associated therewith).

Moreover, while the systems and methods described above provide a measure of fraud prevention, other fraud prevention measures may be implemented as well. Merely by way of example, co-pending, commonly-owned provisional U.S. patent application No. ______, filed on a date even herewith by McGee et al. and entitled “Anti-Fraud Presentation Instruments, Methods and Systems” (attorney docket no. 020375-062010US), the entire disclosure of which is incorporated herein by reference, describes several devices, systems and methods that can be used to further reduce the likelihood of fraud associated with presentation instruments. The anti-fraud measures described in the incorporated application, as well as others, may be implemented as desired with the systems and methods described herein

It should also be appreciated that the methods described above may be performed by hardware components and/or software programs, and thus may be embodied in sequences of machine-executable instructions, which may be used to cause a machine, such as a general-purpose or special-purpose processor or logic circuits programmed with the instructions, to perform the methods. These machine-executable instructions may be stored on one or more machine readable media, such as CD-ROMs or other type of optical disks, floppy diskettes, ROMs, RAMs, EPROMs, EEPROMs, magnetic or optical cards, flash memory, or other types of machine-readable media suitable for storing electronic instructions. Merely by way of example, some embodiments of the invention provide software programs, which may be executed on one or more computers, for performing the methods described above. In particular embodiments, for example, there may be a plurality of software components configured to execute on various hardware devices (such as an point-of-sale terminal, host system and/or instrument-authority system). Alternatively, the methods may be performed by a combination of hardware and software.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for processing a stored-value instrument, the method comprising:
receiving, at an instrument-authority system, a request to authenticate a particular stored-value instrument;
in response to the first transaction, performing a first transaction at the instrument-authority system, wherein the first transaction authenticates the particular stored-value instrument; and
performing a second transaction at the instrument-authority system, wherein the second transaction activates the stored-value instrument, and wherein the stored-value instrument cannot be used until the stored-value instrument has been activated.

2. A method for processing a stored-value instrument, the method comprising:
receiving at a point-of-sale device an identifier identifying a stored-value instrument;
transmitting from the point-of-sale device a request for authentication of the stored-value instrument;
authenticating the stored-value instrument in response to the request for authentication; and
activating the stored-value instrument upon the occurrence of a specified event.

3. A method as recited in claim 2, wherein the method further comprises confirming at the point-of-sale device that payment for the stored-value instrument has been received, and wherein the specified event comprises receiving from the point-of-sale device a confirmation that payment for the stored value instrument has been received.

4. A method as recited in claim 3, wherein confirming that payment for the stored-value instrument has been received comprises receiving input from a clerk indicating that payment has been tendered.

5. A method as recited in claim 3, wherein confirming that payment for the stored-value instrument has been received comprises the point of sale device processing a credit card or debit card transaction related to a purchase of the stored-value instrument.

6. A method as recited in claim 3, wherein the stored-value instrument has associated therewith a second identifier.

7. A method as recited in claim 6, wherein confirming that payment has been received comprises receiving the second identifier.

8. A method as recited in claim 6, wherein the stored-value instrument comprises a first storage device selected from the group consisting of a magnetic stripe, a radio-frequency identification (“RFID”) tag, a memory chip and a printed number, and wherein the first identifier is stored on the first storage device.

9. A method as recited in claim 8, wherein the stored-value instrument comprises a second storage device selected from the group consisting of a magnetic stripe, a radio-frequency identification (“RFID”) tag, a memory chip and a printed number, and wherein the second identifier is stored on the second storage device.

10. A method as recited in claim 9, wherein the first storage device and the second storage device are not the same storage device.

11. A method as recited in claim 2, wherein the request for authentication comprises a request to add additional finds to an account associated with the stored-value instrument, and wherein activating the stored-value instrument comprises activating the additional funds added to the account.

12. A method as recited in claim 2, wherein the stored-value instrument cannot be used until the stored-value instrument has been activated.

13. A method as recited in claim 2, wherein authenticating the stored-value instrument comprises placing an account associated with the stored-value instrument in a frozen state, such that no funds associated with the account may be accessed by a user of the stored-value instrument, and wherein activating the stored-value instrument comprises placing the account in an unfrozen state, such that funds associated with the stored-value instrument can be accessed by the user of the stored-value instrument.

14. A method as recited in claim 2, wherein the stored-value instrument comprises a stored-value card, and wherein the identifier is a card number associated with the stored-value instrument.

15. A method as recited in claim 2, wherein the stored-value instrument comprises a magnetic stripe, wherein the identifier is encoded on the magnetic stripe, and wherein receiving the identifier comprises a clerk swiping the magnetic stripe through a magnetic stripe reader.

16. A method as recited in claim 2, wherein the identifier is represented by a bar code on the stored-value instrument, and wherein receiving the identifier comprises scanning the bar code.

17. A method as recited in claim 2, wherein the stored-value instrument comprises a radio-frequency identification (“RFID”) tag, and wherein receiving the identifier comprises interrogating the RFID tag.

18. A method as recited in claim 2, wherein the stored-value instrument comprises a memory chip, and wherein the identifier is stored on the memory chip.

19. A method as recited in claim 2, wherein the identifier is printed and/or embossed on the stored-value instrument.

20. A method as recited in claim 19, wherein receiving the identifier comprises a clerk inputting the identifier.

21. A method as recited in claim 2, further comprising:
receiving at the point-of-sale device a confirmation that the stored-value card has been authenticated.

22. A method as recited in claim 2, further comprising:
transmitting from the point-of-sale device a request to not activate the stored-value instrument when payment for the stored-value instrument has not been received.

23. A method as recited in claim 22, further comprising:
receiving at the point-of-sale device a notice that the stored-value instrument will not be activated.

24. A method as recited in claim 22, further comprising:
placing the stored-value instrument in an inactive state in response to the request.

25. A method a recited in claim 2, wherein the occurrence of a specified event comprises a specified period of time elapsing.

26. A method as recited in claim 25, wherein the specified period of time is determined by requesting a value from a database.

27. A method as recited in claim 25, wherein the specified period of time is 60 minutes.

28. A method as recited in claim 25, wherein the specified period of time is greater than 15 minutes, but less than 60 minutes.

29. A method for processing a stored-value instrument, the method comprising:
receiving at an instrument-authority system an authentication request from a point-of-sale device, the request for authentication comprising a request to authenticate a stored-value instrument;
authenticating at the instrument-authority system the stored-value instrument in response to the authentication request received from the point-of-sale device;
placing the stored-value instrument into a frozen state, such that funds in an account associated with the stored-value instrument cannot be accessed by a user of the stored-value instrument; and
activating the stored-value instrument upon the occurrence of a specified event, such that funds in the account associated with the stored-value instrument can be accessed by a user of the stored-value instrument.

30. A system for processing a stored-value instrument, the system comprising:
a point of sale device configured to:
receive an identifier identifying a stored-value instrument;
transmit a request for authentication of the stored value instrument; and
an instrument-authority system in communication with the point-of-sale device, the instrument authority system comprising:
a communications system;
a processor in communication with the communications system; and
a memory coupled with the processor, the memory comprising a computer-readable storage medium having a computer-readable program embodied therein for directing operation of the instrument-authority system, the computer-readable program comprising:
instructions for receiving the request for authentication;
instructions for authenticating the stored-value instrument in response to the request for authentication; and
instructions for activating the stored-value instrument upon the occurrence of a specified event.

31. A system for processing a stored-value instrument, the system comprising:
a communications system;
a processor in communication with the communications system; and
a memory coupled with the processor, the memory comprising a computer-readable storage medium having a computer-readable program embodied therein for directing operation of the system, the computer-readable program comprising:
instructions for receiving an authentication request from a point-of-sale device, the request for authentication comprising a request to authenticate a stored-value instrument;
instructions for authenticating the stored-value instrument in response to the authentication request received from the point-of-sale device;
instructions for placing the stored-value instrument in a frozen state, such that funds in an account associated with the stored-value instrument cannot be accessed by a user of the stored-value instrument; and
instructions for activating the stored-value instrument upon the occurrence of a specified event, such that finds in the account associated with the stored-value instrument can be accessed by a user of the stored-value instrument.

32. A software program embodied on at least one computer readable medium, the software program comprising instructions executable by one or more computers to:
receive an authentication request from a point-of-sale device, the request for authentication comprising a request to authenticate a stored-value instrument;
authenticate the stored-value instrument in response to the authentication request received from the point-of-sale device;
place the stored-value instrument in a frozen state, such that fluids in an account associated with the stored-value instrument cannot be accessed by a user of the stored-value instrument; and
activate the stored-value instrument upon the occurrence of a specified event, such that funds in the account associated with the stored-value instrument can be accessed by a user of the stored-value instrument.
